(19) United States
(12) Patent Application Publication
(10) Pub. No.: US 2025/0246320 A1
(43) Pub. Date: Jul. 31, 2025

(54) System and Method for Facilitating Collaboration Between Two Different Entities

(71) Applicant: BioQode LLC, Clinton, NJ (US)

(72) Inventors: Balal Mian, Elmira, NY (US); Kaiser Pathan, Pittstown, NJ (US)

(73) Assignee: BioQode LLC, Clinton, NJ (US)

(21) Appl. No.: 18/986,048

(22) Filed: Dec. 18, 2024

Related U.S. Application Data
(60) Provisional application No. 63/614,784, filed on Dec. 26, 2023.

(51) Int. Cl. G16H 80/00; G06Q 50/00; G16H 10/20; G16H 10/60; G16H 70/20

(52) U.S. Cl. CPC G16H 80/00; G06Q 50/01; G16H 10/20; G16H 10/60; G16H 70/20

(57) ABSTRACT

A system and method for facilitating collaboration between a first entity and a second entity are disclosed. The system includes portals for the first and second entities, accessible via smartphone applications or web login, enabling the first entity to create profiles, filter trials, and initiate secure communications, while allowing the second entity to upload therapeutic pipelines, classify content, and share updates. A virtual platform hosts data on servers, facilitating secure, real-time communication and interaction. Key components include a communication subsystem for real-time messaging with non-disclosure agreement management, a data management module for storing profiles and maintaining audit trails, and a second data management module leveraging machine learning to provide personalized recommendations and predict collaboration trends. An artificial intelligence controller integrates external datasets and dynamically refines workflows. Additional modules ensure privacy and security, deliver real-time updates, and gather feedback, enabling efficient, secure, and goal-oriented collaboration.

### CROSS-REFERENCE TO RELATED APPLICATIONS

This application claims the benefit of U.S. Provisional Patent Application No. 63/614,782 filed Dec. 26, 2023 entitled “Virtual platform between bio pharma and clinicians”, which is incorporated by reference herein in its entirety

### TECHNICAL FIELD OF THE INVENTION

The present disclosure relates to the field of communication and collaboration platforms, specifically to systems and methods that facilitate secure, efficient, and targeted interactions between clinicians and entities such as biopharmaceutical entities. The present disclosure leverages advanced data management, machine learning, and artificial intelligence technologies to streamline the exchange of research opportunities, clinical trial information, and therapeutic updates, while ensuring privacy and regulatory compliance. The system is particularly applicable in the domains of clinical research, pharmaceutical development, and healthcare innovation, enabling optimized partnerships and data-driven decision-making between medical professionals and industry stakeholders.

### BACKGROUND OF THE INVENTION

Effective collaboration and communication between distinct professional groups is critical for achieving shared objectives, particularly in industries reliant on research, innovation, and timely decision-making. Despite advancements in digital technology, many industries still rely on fragmented and outdated methods for interaction, such as email chains, manual documentation, or isolated software tools. These approaches often lack real-time capabilities, fail to provide secure environments for sharing sensitive information, and do not effectively leverage modern data analytics to enhance productivity.

Existing platforms typically operate in silos, limiting the ability of users to establish meaningful connections or access comprehensive insights tailored to their specific needs. Additionally, these systems often lack robust privacy measures, making them unsuitable for discussions involving proprietary data, confidential agreements, or confidential information. The inefficiency of such methods impedes progress, delays critical decisions, and restricts the potential for innovation and mutual benefit.

The increasing complexity of modern industries, coupled with the demand for interdisciplinary collaboration, highlights the need for a unified platform that integrates secure communication, advanced data management, and intelligent recommendation capabilities.

### BRIEF SUMMARY OF THE INVENTION

This summary is provided to introduce concepts related to systems and methods that facilitate secure, efficient, and targeted interactions between different entities. The concepts are further described below in the detailed description. This summary is not intended to be used to limit the scope of the claimed subject matter.

The present disclosure envisages a system for facilitating collaboration between a first entity and a second entity. The system includes a first entity portal, a second entity portal, a virtual platform, a communication subsystem, a data management module, a second data management module, an artificial intelligence (AI) controller, a content update provider, a first entity survey module, and a privacy and security module. The first entity portal is accessible via smartphone applications or web login, configured to allow the first entity to create and manage profiles specifying first entity specialties, research interests, and collaboration goals; filter and select trials of the first entity and the second entity based on therapeutic area and trial phase; and initiate secure communications with the second entity. The second entity portal is accessible via smartphone applications or web login, configured to allow the second entity to upload and manage therapeutic pipelines, first entity trial updates, and research opportunities; classify content by trial phase, therapeutic area, and geographic region; and interact with the first entity based on shared research goals.

The virtual platform is hosted on a support server and a support cloud server for managing data storage, communication processing, and entities interaction logs. Further, the virtual platform is hosted on a network server configured for secure, real-time data exchange between the first entity portal and the second entity portal.

The communication subsystem is configured to facilitate real-time messaging between the first and second entities; transmit pre-configured non-disclosure agreements upon initiating sensitive discussions to ensure privacy; and log communication events, timestamps, and non-disclosure agreement (NDA) metadata.

The data management module is configured to store and organize first and second entities' profiles, message logs, and interaction histories; and maintain audit trails for regulatory compliance.

The second data management module employs machine learning to analyze interactions of the first and second entities to generate personalized recommendations for first entity trials, collaborations, and connections; identify potential synergies using external datasets; and predict emerging trends in the first entity and the second entity collaborations.

The artificial intelligence controller is configured to integrate external data sources, including first entity surveys, content management system (CMS) data, National Comprehensive Cancer Network (NCCN) guidelines, and medical journal publications; and dynamically update communication workflows and recommendations.

The content update provider enables the second entity to deliver real-time updates on therapeutic products, first entity trials, and collaboration opportunities.

The first entity survey module is integrated into the platform to gather and analyze clinician feedback on trials and collaborations.

The privacy and security module is configured to encrypt data during transmission and storage; provide entity-controlled permissions for content access; and automate log deletion for NDA-protected discussions after a predefined period.

Further, the communication subsystem categorizes messages by therapeutic area, trial phase, or sender department for streamlined tracking.

Yet further, the second data management module utilizes natural language processing (NLP) to analyze message content and refine collaboration suggestions. The AI controller can dynamically adjust recommendations based on real-time interactions of the first entity and the second entity. The content update provider can include tools for automating the delivery of trial status updates to matched clinicians.

The privacy and security module can incorporate multi-factor authentication for enhanced verification of the first entity or the second entity. The first entity survey module can anonymize feedback data for the second entity analysis while preserving clinician confidentiality. The network server can employ distributed ledger technology to enhance data integrity and traceability.

The first entity portal can provide a dashboard displaying trial recommendations, recent communications, and upcoming collaboration opportunities. The AI controller can predict emerging research trends and suggests partnerships accordingly.

The present disclosure further envisages a method for enabling collaboration between a first entity and a second entity using a virtual platform. The method includes providing a first entity portal for the first entity to access via smartphone applications or web login, wherein the first entity creates profiles specifying research interests, therapeutic expertise, and collaboration goals, and filters trials of the first entity and the second entity by criteria including therapeutic area or trial phase; providing a second entity portal for the second entity to access via smartphone applications or web login, wherein the second entity uploads and classifies content, including therapeutic pipelines and first entity trial updates; and targets the first entity based on research alignment; facilitating communication through a communication subsystem, by enabling real-time messaging between the first entity and the second entity, transmitting pre-configured NDAs upon initiating sensitive discussions, and recording interaction logs and associated metadata for traceability; analyzing interactions of the first and second entities using a second data management module employing machine learning to generate personalized recommendations for first entity trials, collaborations, and partnerships; predict potential synergies between first and second entities; and identify trends in the engagement of the first and second entities; utilizing an artificial intelligence controller to integrate external data from first entity surveys, CMS datasets, NCCN guidelines, and medical journals; and generate recommendations and workflows based on evolving first and second entities behavior; and enabling the second entity to deliver trial updates and therapeutic content through a content update provider; gathering feedback via a first entity survey module for analysis and reporting; and securing interactions with a privacy and security module configured to encrypt data, manage permissions, and automate log deletion for NDA-protected discussions.

The method further comprises enabling clinicians to sort potential collaborations by geographic location of the trial sites or sponsors. The method further comprises integrating external electronic health records (EHRs) into the virtual platform for streamlined data sharing. The method further comprises enabling clinicians to receive real-time alerts for updates matching their first entity interests. The method further comprises enabling the second entity to access engagement metrics, including response rates and message open rates, for optimizing communication strategies.

Other and further aspects and features of the disclosure will be evident from reading the following detailed description of the embodiments, which are intended to illustrate, not limit, the present disclosure.

### BRIEF DESCRIPTION OF THE SEVERAL VIEWS OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and methods that are consistent with the subject matter as claimed herein. It should be understood, however, that the invention is not limited to the precise arrangements and instrumentalities shown.

In the drawings:

FIG. 1 illustrates a system architecture of a virtual platform including a clinical portal, a biopharma portal, a communication subsystem, a data management module, a second data management module, an AI controller, as well as their interconnections, in accordance with an embodiment of the present disclosure;

FIG. 2 illustrates a functional workflow of the system, outlining the interactions between users, the communication subsystem, the data management module, demonstrating the operational processes that enable secure collaboration and dynamic data exchange, in accordance with an embodiment of the present disclosure;

FIG. 3 illustrates a representation of a user interface (UI) architecture, detailing dashboard layouts for both user groups, including modules for profile management, messaging, trial recommendations, and engagement analytics, along with the integration of privacy controls, in accordance with an embodiment of the present disclosure;

FIG. 4 illustrates the data flow and processing architecture within the system, emphasizing the integration and interactions between system components to facilitate collaboration between clinicians and entities, in accordance with an embodiment of the present disclosure; and

FIGS. 5A and 5B illustrate a flowchart of the steps in a method of the platform, showcasing the sequence of operations from user access and profile creation to real-time communication, data analysis, content updates, and secure data handling, emphasizing iterative refinement and user-centric outcomes.

The figures depict embodiments of the disclosure for purposes of illustration only. One skilled in the art will readily recognize from the following description that alternative embodiments of the structures and methods illustrated herein may be employed without departing from the principles of the disclosure described herein.

### DETAILED DESCRIPTION OF THE INVENTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

Definitions of one or more terms that will be used in this disclosure are described below without limitations. For a person skilled in the art, it is understood that the definitions are provided just for the sake of clarity and are intended to include more examples than just provided below.

Clinical Portal 102: A user interface accessible via web or mobile applications, designed for professionals to create profiles, manage interests, and communicate securely with other stakeholders in the system. While referred to as a “clinical portal,” it may be adapted for use by other professional groups with similar needs for profile management and collaboration.

Industry portal 104: A complementary user interface accessible via web or mobile applications, allowing entities to upload, manage, and share information such as research opportunities, product pipelines, and collaborations. The industry portal may be accessible by a biopharmaceutical company or other medical company. This term is not limited to biopharmaceutical applications and may extend to other industries requiring similar functionalities.

Virtual Platform 106: The overarching system that hosts and facilitates the interaction between portals, integrating components such as servers, communication tools, and analytical engines. The term broadly encompasses any system designed to enable multi-user collaboration through centralized or distributed computing resources.

Support Server 108 and Support Cloud Server 110: Infrastructure elements responsible for data storage and computational processing. These terms include, but are not limited to, physical servers, cloud-based systems, or hybrid implementations that support the platform's operations.

Network Server 112: A hardware or software component that facilitates real-time, secure data exchange between system elements. This definition is inclusive of distributed or decentralized systems, such as those employing blockchain or other advanced networking technologies.

Communication Subsystem: A system module enabling real-time interactions between users, including messaging, data sharing, and the transmission of non-disclosure agreements (NDAs). The term covers any comparable communication system capable of managing secure and logged exchanges between multiple parties.

Data Management Module 116: A component responsible for organizing, storing, and retrieving user profiles, interaction histories, and communication logs. This term broadly refers to systems performing similar functions, including database management systems and integrated data repositories.

Second data management module 118: A software engine utilizing algorithms, such as machine learning or artificial intelligence, to analyze large datasets and provide actionable insights. This term is not limited to the specific techniques described and includes other data analysis tools capable of identifying patterns, trends, or recommendations.

AI Controller 120: A module designed to integrate external data sources and dynamically refine system workflows and recommendations. The term applies broadly to any artificial intelligence system that supports real-time decision-making or process optimization.

Content Update Provider 122: A feature enabling real-time dissemination of updates, such as trial information, research developments, or collaborative opportunities. The term includes any tool or mechanism that delivers similar updates within or outside the platform context.

Privacy and Security Module: A system component implementing encryption, access control, and data compliance measures. The term broadly includes any system or module designed to protect user data and maintain privacy, irrespective of specific encryption methods or protocols.

First Entity Survey Module 126: A tool integrated into the platform to gather and analyze feedback from users. This term includes any system capable of collecting structured or unstructured user inputs and generating insights for system improvement or operational enhancement.

Non-disclosure agreement (NDA): A legal agreement transmitted through the communication subsystem to ensure confidentiality during sensitive discussions. The term broadly includes any agreement, whether pre-configured or dynamically generated, designed to maintain privacy in professional communications.

Recommendation Engine: An algorithm or software tool that generates personalized suggestions for users, including potential collaborations, trials, or content. This term applies to any system providing tailored outputs based on user data and interactions.

The technical problem addressed by the present disclosure arises from inefficiencies in facilitating effective collaboration and communication between distinct professional groups, particularly in domains that require secure exchanges of sensitive information, streamlined workflows, and data-driven decision-making. Existing systems are fragmented, relying on disconnected tools that fail to provide real-time capabilities or comprehensive integration. These limitations hinder meaningful interactions, delay critical discussions, and restrict users from accessing actionable insights tailored to their needs. Furthermore, the lack of robust privacy and security mechanisms in traditional methods creates significant challenges when dealing with proprietary data or sensitive communications.

The present disclosure provides a technical solution in the form of an integrated virtual platform that bridges the gap between such professional groups. The present disclosure employs advanced components, including a dual-portal system for user-specific interfaces, a communication subsystem for secure and real-time exchanges, and data management modules for organizing and storing interaction histories. The platform leverages machine learning and artificial intelligence to analyze user inputs, interactions, and external datasets, generating personalized recommendations and actionable insights. A robust privacy and security module ensures compliance with regulatory standards and safeguards data through encryption, access controls, and automated log management. These features collectively enable users to engage seamlessly, access relevant opportunities, and make informed decisions within a secure and adaptable environment.

The technical advancement introduced by this present disclosure lies in its holistic approach to integrating secure communication, data analytics, and machine learning within a single platform. Unlike existing solutions, which operate in isolation and require manual coordination, the invention dynamically connects users, processes vast datasets, and evolves through iterative feedback loops to remain responsive to user needs. This adaptive and intelligent design not only enhances the efficiency and effectiveness of professional collaborations but also ensures privacy and compliance, setting a new standard for interaction systems in research, innovation, and other high-stakes fields.

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

Various embodiments are further described herein with reference to the accompanying figures. It should be noted that the description and figures relate to exemplary embodiments and should not be construed as a limitation to the subject matter of the present disclosure. It is also to be understood that various arrangements may be devised that, although not explicitly described or shown herein, embody the principles of the subject matter of the present disclosure. Moreover, all statements herein reciting principles, aspects, and embodiments of the subject matter of the present disclosure, as well as specific examples, are intended to encompass equivalents thereof. Yet further, for the sake of brevity, operation or working principles pertaining to the technical material that is known in the technical field of the present disclosure have not been described in detail so as not to unnecessarily obscure the present disclosure.

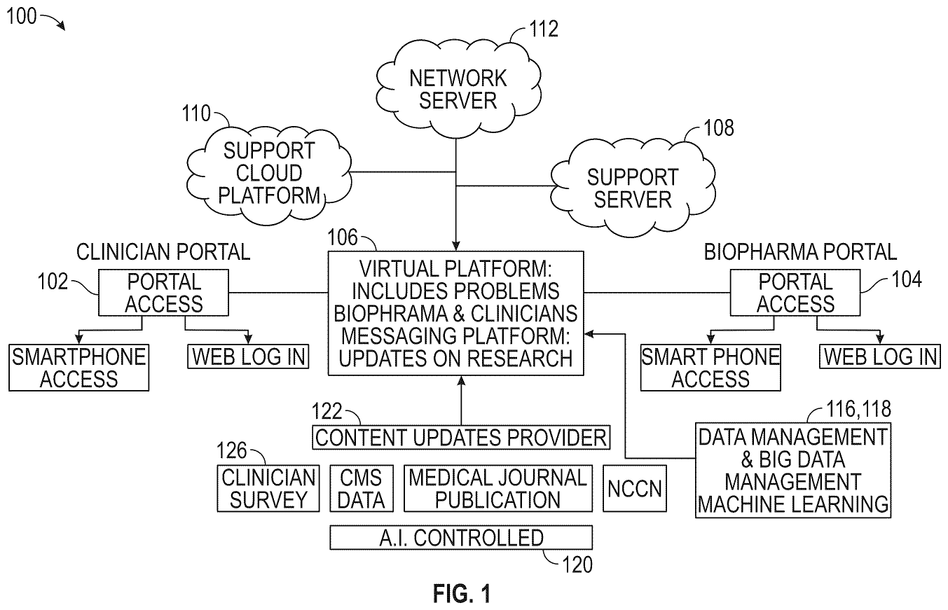

FIG. 1 illustrates an overview of a system 100 that facilitates collaboration between different entities, say clinicians and biopharmaceutical entities. FIG. 1 depicts components of the system 100 implementing a virtual platform 106 showcasing their interconnections and functionalities.

At the center of the system 100 is the virtual platform 106, which is hosted on a combination of servers for optimal performance and security. Further, support server 108 and support cloud server 110 are displayed as foundational elements, responsible for data storage, processing, and user interaction management. The support and support cloud servers 108, 110 are linked to a network server 112, which ensures secure, real-time data exchange between the other components of the system 100.

Clinical portal 102 and industry portal 104 are shown as distinct yet interconnected entities in the system 100. In an example, the clinical portal 102 may be referred to as a first entity portal, while the industry portal 104 may be referred to as a second entity portal. The clinical portal 102 is designed for access by clinicians and includes features such as profile creation, trial selection, and secure communication initiation. The industry portal 104, accessible by biopharmaceutical entities, enables the upload and classification of therapeutic pipelines and research opportunities. In FIG. 1, arrows indicate bidirectional communication between these portals 102, 104, symbolizing the platform's two-way interaction capability.

Further, the system 100 includes a communication subsystem (not shown in figures), which connects the clinical portal 102 and the industry portal 104. This communication subsystem supports real-time messaging and incorporates mechanisms for transmitting non-disclosure agreements (NDAs) to secure sensitive discussions. The communication subsystem also logs interaction metadata, ensuring traceability and compliance.

The system 100 also includes a data management module 116 positioned beneath the communication subsystem, signifying its role in organizing and storing interaction histories, profiles, and message logs.

Further, the system 100 also includes a privacy and security module (not shown in figure) that demonstrates the encryption and privacy measures applied to all stored and transmitted data.

The system 100 further includes a second data management module 118 and an artificial intelligence controller 120, which are prominently displayed, highlighting their analytical and predictive capabilities. The second data management module 118 is configured for analyzing user interactions and external datasets to generate personalized recommendations. The second data management module 118 is interconnected with the AI controller 120, which integrates external data sources and dynamically refines platform workflows.

Additionally, the system 100 also includes a content update provider 122 and a first entity survey module 126, which are illustrated as specialized subsystems. The content update provider 122 facilitates the dissemination of trial updates and collaboration opportunities, while the first entity survey module 126 gathers and analyzes clinician feedback to improve the platform's functionality.

In FIG. 1, connecting all these modules/elements of the system 100 is a secure network, represented by solid lines, indicating pathways for data transmission and interaction. These lines emphasize the platform's robust and integrated design, ensuring seamless and efficient operation. In summary, FIG. 1 serves as a high-level depiction of the system's architecture, providing an intuitive understanding of how the various components collaborate to deliver a comprehensive solution for clinician-biopharmaceutical interactions.

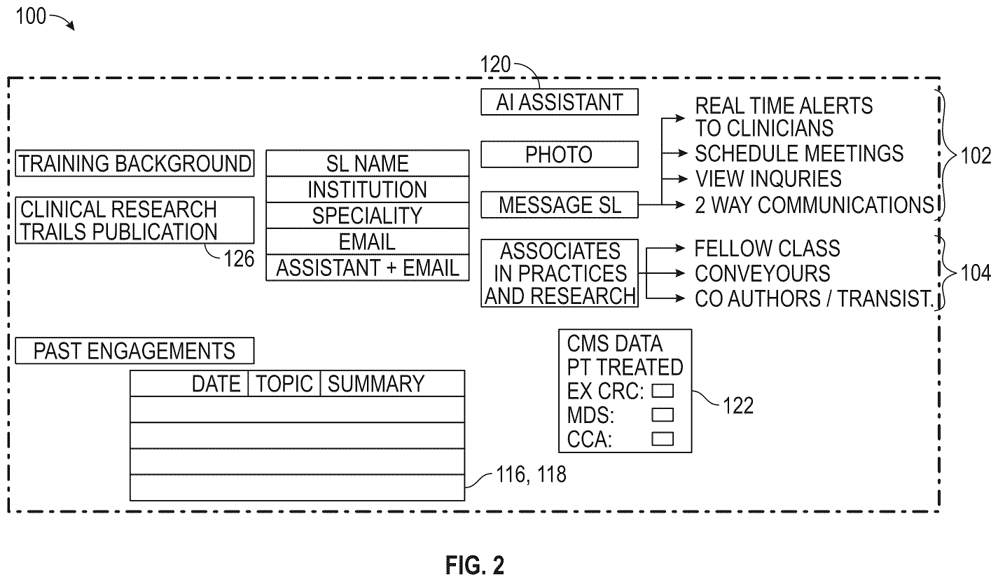

FIG. 2 provides a detailed functional flow diagram of the operational processes within the system 100 for facilitating collaboration between first and second entities such as clinicians and industrial (e.g., biopharmaceutical) entities. FIG. 2 emphasizes the step-by-step interactions between users, system components, and data pathways to achieve the platform's objectives.

At the top left portion of FIG. 2, user inputs are divided into two streams: one representing clinicians and the other for biopharmaceutical entities. These streams lead to the respective portals: the clinical portal 102 and the industry portal 104. Clinicians input information such as their profiles, clinical interests, and collaboration goals, while biopharmaceutical entities upload therapeutic pipelines, classify trial data, and specify their target clinician demographics.

From the clinical portal 102, an arrow flows to a profile creation and filtering module (not shown in figures), where clinicians can define and refine their preferences based on therapeutic area, trial phase, or geographic location. Similarly, the industry portal 104 feeds into the content update provider 122, allowing entities to organize and upload trial updates, research opportunities, and product information.

Both streams converge at the virtual platform 106, which acts as the central hub for data exchange and processing. Then, the network server 112 facilitates secure real-time data sharing between these inputs, while the support server 108 and the support cloud server 110 handle the data storage and processing tasks required to maintain operational efficiency.

Next, the communication subsystem (not shown in figures) directs messaging between users occurs. The clinicians and biopharma entities can exchange real-time messages, using the communication subsystem. This communication subsystem includes an automatic trigger for NDAs during sensitive discussions, as a branching process that ensures privacy and logs metadata related to each interaction. The NDAs can be specific to the biopharmaceutical entity. The NDA may be pre-approved by the biopharmaceutical entity.

In some existing instances, a clinician and a biopharmaceutical entity may execute an NDA for a first project. The NDA may be submitted to the legal department of the biopharmaceutical entity for approval. This may take several days or weeks. The clinician and the biopharmaceutical entity may decide to expand the scope of the first project or engage for a second project. Existing systems typically require a second NDA to be submitted to the legal department of the biopharmaceutical company for approval. This can lead to delays in a project or expending additional resources. The current system 100 can include NDAs that are preapproved by the biopharmaceutical entity. This can allow the NDA to be executed by the clinician and the biopharmaceutical entity without the need to submit the NDA to biopharmaceutical entity's legal department, thereby expediting the process.

After the communication subsystem, the data management module 116 stores the logs, profiles, and interaction histories generated by user activity. The data management module 116 is linked to the privacy and security module (not shown in figures), which encrypts stored data and implements user-controlled permissions. Further, a feedback loop to the communication subsystem reflects the automated log deletion for NDA-protected discussions after a predefined period.

The second data management module 118 processes user interactions and external datasets, including the feedback collected via the first entity survey module 126. This second data management module 118 gathers responses from clinicians about trials and collaborations, with results feeding into the second data management module to improve recommendation algorithms.

The AI controller 120 can integrate external datasets, such as content management system (CMS) data, National Comprehensive Cancer Network (NCCN) guidelines, and medical journal publications, to refine and dynamically update recommendations and workflows. This functionality is linked to both the clinician and biopharma portals, ensuring that updated suggestions and personalized content are delivered directly to users.

The content update provider 122 is depicted as a real-time dissemination tool for biopharmaceutical entities to share updates on trials, collaborations, and research opportunities. The system 100 shown in FIG. 2 is encapsulated by secure boundaries, representing the comprehensive privacy and encryption protocols in place, emphasizing data integrity and user trust. Arrows depicting feedback loops and iterative learning illustrate the system's adaptive capabilities, allowing it to evolve with user activity and external trends. In essence, FIG. 2 illustrates the functional workflow and interactions within the system 100, showcasing how its components harmonize to enable streamlined, secure, and effective collaboration between clinicians and biopharmaceutical entities.

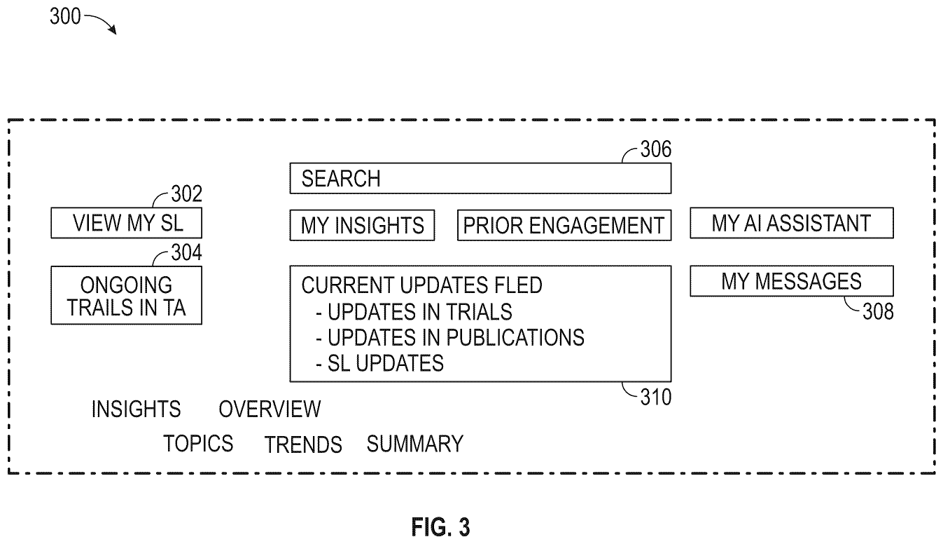

FIG. 3 illustrates the system's user interface (UI) architecture 300, detailing the functional layouts and features available to clinicians and biopharmaceutical entities through their respective portals 102, 104. This UI architecture 300 highlights the design and flow of user interactions within the virtual platform 106, demonstrating how the system 100 supports efficient navigation and task execution.

In the UI architecture 300, login interfaces (not shown in figures) for both the clinical portal 102 and the industry portal 104 may be included. These login interfaces provide user authentication, including options for multi-factor authentication as implemented by the privacy and security module (not shown in figures). Upon successful login, the users are directed to their respective dashboards, which serve as the central navigation points for accessing the platform's features.

In an embodiment, in the UI architecture 300, a clinician/pharma dashboard comprises one or more modules such as a profile management module 302, a trial search and filtering module 306, a message center module 308, and a survey feedback tool 310.

The profile management module 302 allows clinicians to input and update their information, including therapeutic expertise, research interests, and collaboration goals. Further, a submenu 304 is provided for uploading documents (e.g., CVs, publications, or certifications) is included.

The trial search and filtering module 306 may include a graphical interface with dropdown menus and sliders that enables clinicians to filter clinical trials by therapeutic area, phase, and geographic location. This module 306 is powered by the second data management module 118, which provides personalized recommendations based on user preferences and interaction history.

The message center module 308 can be a centralized hub for real-time communication with biopharmaceutical entities. Each message is tagged with metadata, such as sender department (e.g., clinical development, commercial, or medical), ensuring clarity and prioritization.

The survey and feedback tool 310 can allow clinicians to provide input on trials and collaborations, feeding into the first entity survey module 126 for further analysis.

FIG. 3 provides a detailed visualization of the user interface architecture, emphasizing the system's intuitive design and robust feature set, which collectively enable seamless and secure interactions between clinicians and biopharmaceutical entities.

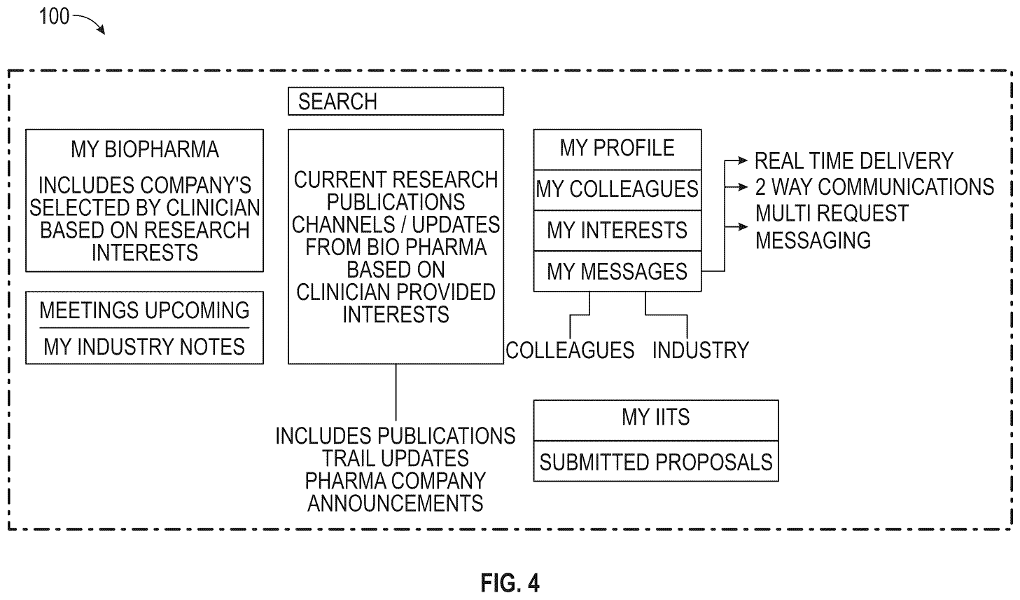

FIG. 4 illustrates the data flow and processing architecture within the system 100, emphasizing the integration and interactions between the system's key components to facilitate collaboration between clinicians and biopharmaceutical entities. FIG. 4 provides a comprehensive view of how data is generated, transmitted, analyzed, and utilized to achieve the platform's objectives.

At an input stage, user-generated data flows into the system through two main channels: the clinical portal 102 and the industry portal 104. Clinicians provide inputs such as profiles, clinical interests, research goals, and feedback through structured forms and dynamic interfaces. Concurrently, biopharmaceutical entities upload data including trial details, therapeutic pipelines, and collaboration opportunities. These inputs are directed into the system's core modules for further processing.

In an embodiment, a data ingestion layer is provided as a first processing stage, which is responsible for validating and standardizing the incoming data from the clinical portal 102 and the industry portal 104. This data ingestion layer ensures that profiles, messages, and trial details conform to predefined formats and are free of errors. From here, the input data is forwarded to the data management module 116, where the data is organized into structured repositories for storage and retrieval.

The network server 112 acts as the central communication hub, facilitating secure real-time data exchange between the clinical portal 102 and industry portal 104. The network server 112 employs cryptographic protocols and secure socket layers to ensure that all transmitted data is encrypted and tamper-proof. Simultaneously, the support server 108 and support cloud server 110 handle the storage of large datasets, such as user interaction logs and trial classifications, enabling seamless data accessibility across the platform.

Next, the communication subsystem (not shown in figures) manages real-time interactions. This subsystem processes messaging data, including text, metadata, and timestamps, ensuring smooth and secure exchanges between users. Pre-configured non-disclosure agreements (NDAs) are transmitted through this communication subsystem whenever sensitive discussions are initiated. The logged communication data is passed to the privacy and security module (not shown in figures) for encryption and permission-based access management.

The second data management module 118 and the AI controller 120 are central to the system's analytical capabilities. The second data management module 118 ingests user interaction data and applies machine learning algorithms to identify patterns, predict collaboration opportunities, and recommend clinical trials or partnerships. External datasets, such as CMS data, NCCN guidelines, and medical journals, are integrated by the AI controller 120 to refine these recommendations further. This processing results in actionable insights that are fed back into the clinician and biopharma portals to improve user engagement.

In an embodiment, the content update provider 122 and the first entity survey module 126 are depicted as modules that generate additional data. The content update provider 122 disseminates real-time information about trials and therapeutic advancements to clinicians, ensuring that they remain informed about the latest opportunities. The first entity survey module 126 gathers structured feedback from clinicians, which is anonymized and analyzed by the second data management module 118 to enhance platform features and refine trial designs.

At an output stage, processed data is presented to users through dashboards and notification systems in their respective portals 102, 104. Clinicians receive personalized trial recommendations, updates, and secure messages, while biopharmaceutical entities are provided with clinician analytics, engagement metrics, and feedback summaries.

The entirety of the data flow is encapsulated within the privacy and security module, which provides end-to-end encryption and ensures compliance with regulations such as the Health Insurance Portability and Accountability Act (HIPAA). Automated log deletion for NDA-protected discussions and user-controlled content permissions are explicitly shown as part of the module's processes.

FIG. 4 demonstrates the sophistication and integration of the system's data flow architecture, emphasizing its ability to securely and efficiently process large volumes of data while providing valuable, actionable insights to clinicians and biopharmaceutical entities alike.

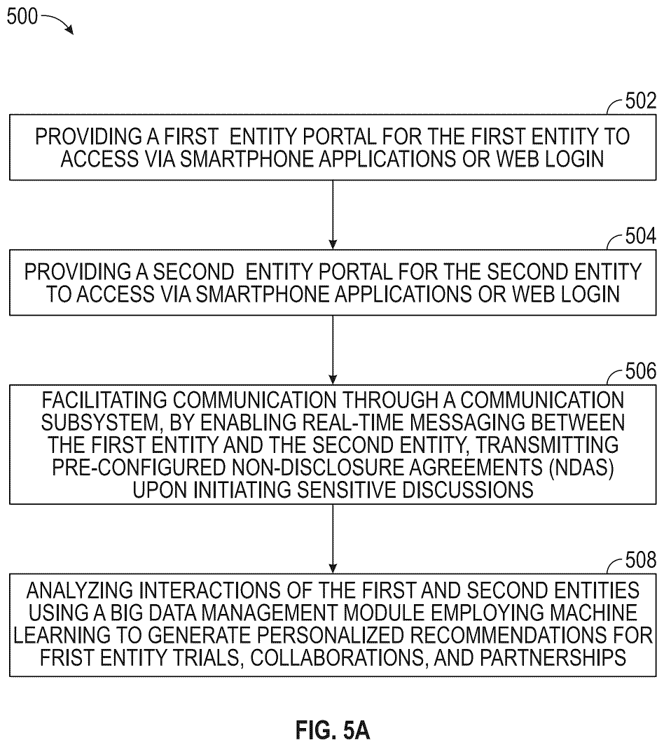

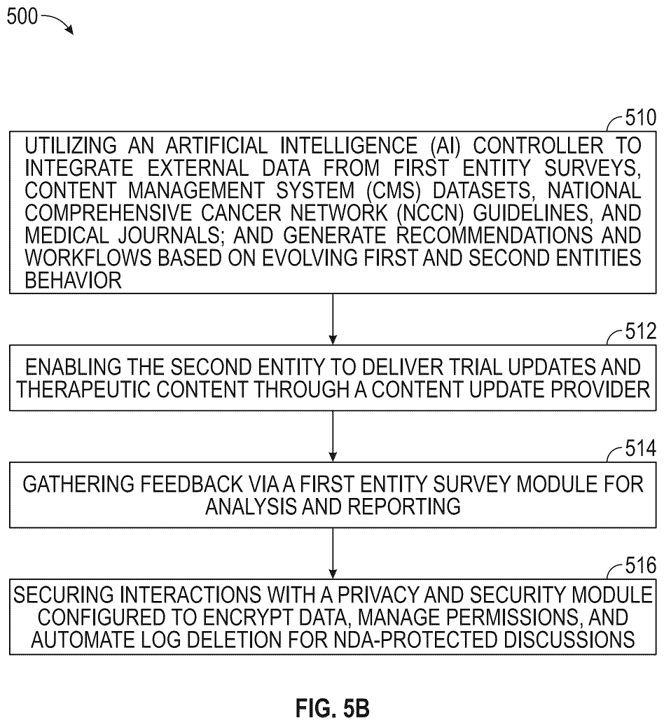

FIGS. 5A and 5B illustrate an exemplary method 500 for enabling collaboration between a first entity and a second entity using a virtual platform 100, in accordance with an embodiment of the present disclosure. The order in which the method 500 is described is not intended to be construed as a limitation, and any number of the described method blocks may be combined in any order to implement the methods, or an alternative method. Furthermore, method 500 may be implemented by processing resource or computing device(s) through any suitable hardware, non-transitory machine-readable instructions, or a combination thereof.

At step 502, the method 500 includes providing a first entity portal 102 for the first entity to access via smartphone applications or web login, wherein the first entity creates profiles specifying research interests, therapeutic expertise, and collaboration goals, and filters trials of the first entity and the second entity by criteria including therapeutic area or trial phase.

At step 504, the method 500 includes providing a second entity portal 104 for the second entity to access via smartphone applications or web login, wherein the second entity uploads and classifies content, including therapeutic pipelines and first entity trial updates; and targets the first entity based on research alignment.

At step 506, the method 500 includes facilitating communication through a communication subsystem 114, by enabling real-time messaging between the first entity and the second entity, transmitting pre-configured NDAs upon initiating sensitive discussions, and recording interaction logs and associated metadata for traceability.

At step 508, the method 500 includes analyzing interactions of the first and second entities using a second data management module 118 employing machine learning to generate personalized recommendations for first entity trials, collaborations, and partnerships; predict potential synergies between first and second entities; and identify trends in the engagement of the first and second entities.

At step 510, the method 500 includes utilizing an AI controller 120 to integrate external data from first entity surveys, CMS datasets, NCCN guidelines, and medical journals; and generate recommendations and workflows based on evolving first and second entities behavior.

At step 512, the method 500 includes enabling the second entity to deliver trial updates and therapeutic content through a content update provider 122.

At step 514, the method 500 includes gathering feedback via a first entity survey module 126 for analysis and reporting.

At step 516, the method 500 includes securing interactions with a privacy and security module configured to encrypt data, manage permissions, and automate log deletion for NDA-protected discussions.

The platform enables clinicians to sort potential collaborations by the geographic location of trial sites or sponsors, allowing efficient resource allocation and reducing logistical complexities.

The virtual platform integrates external electronic health records (EHRs) into its infrastructure. This integration facilitates seamless data sharing, accelerates trial processes, and minimizes redundancies by providing centralized access to relevant clinical information.

The second entity is provided with access to engagement metrics such as response rates, message open rates, and interaction frequencies. These insights enable the second entity to optimize its communication strategies and improve targeting precision.

The disclosed method offers significant advantages in enabling collaboration between a first entity and a second entity using a virtual platform. It enhances operational efficiency by providing dedicated portals tailored to the needs of each entity. The first entity portal enables the creation of detailed profiles and the application of automated filters, allowing users to identify relevant trials and collaboration opportunities with minimal manual effort. Similarly, the second entity portal facilitates content organization and targeted outreach, ensuring that interactions are aligned with mutual research interests and goals.

The method improves communication by integrating a robust real-time messaging system that supports instant exchanges of information and expedites decision-making. The inclusion of pre-configured non-disclosure agreements ensures that sensitive discussions are conducted securely and in compliance with legal requirements, while the system's ability to log and archive interactions provides comprehensive traceability, enhancing accountability and enabling regulatory adherence.

By leveraging a second data management module and AI-driven analytics, the platform delivers personalized recommendations and predicts synergies between entities, driving more meaningful and impactful collaborations. The integration of external data sources and EHR systems further streamlines workflows by centralizing critical information, reducing redundancies, and improving data accessibility. Engagement insights, such as response rates and interaction trends, empower entities to refine their strategies and optimize communication efforts effectively.

Moreover, the platform addresses privacy and security comprehensively, employing data encryption, permission management, and automated log deletion to safeguard sensitive information. Geographic filtering capabilities allow users to prioritize collaborations based on logistical considerations, while the ability to gather and analyze feedback ensures continuous improvement of platform functionalities. Overall, the method fosters a seamless, secure, and data-driven approach to collaboration, significantly improving the efficiency and quality of interactions in clinical and research settings.

The above description does not provide specific details of the manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the disclosure, numerous references may be made regarding servers, services, engines, modules, interfaces, portals, platforms, or other systems formed from computing devices. It should be appreciated that the use of such terms is deemed to represent one or more computing devices having at least one processor configured to or programmed to execute software instructions stored on a computer-readable tangible, non-transitory medium also referred to as a processor-readable medium. For example, a server can include one or more computers operating as a web server, database server, or another type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “capturing,” or “processing,” or “executing,” or “extracting,” “applying,” “generating,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, magnetic-optical disks, read-only memories (ROMs), random access memories (RAMs), EPROMS, EEPROMs, magnetic or optical cards, or any type of media suitable for storing electronic instructions, and each coupled to a computer system bus.

Further, the terminology used herein is for the purpose of describing particular embodiments only and is not intended to be limiting to the disclosure. It would be appreciated if several of the above-disclosed and other features and functions, or alternatives thereof, could be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

What is claimed is:

1. A system for facilitating collaboration between a first entity and a second entity, comprising:
a first entity portal accessible via at least one of a smartphone application or web login, the first entity portal configured to allow the first entity to:
create and manage profiles specifying at least one of first entity specialties, research interests, and collaboration goals;
filter and select clinical trials of the first entity and the second entity based on therapeutic area and clinical trial phase; and
initiate secure communications with the second entity;
a second entity portal accessible via at least one of a smartphone application or web login, the second entity portal configured to allow the second entity to:
upload and manage therapeutic pipelines, first entity trial updates, and research opportunities;
classify content by clinical trial phase, therapeutic area, and geographic region; and
interact with the first entity based on shared research goals;
a communication subsystem configured to:
facilitate real-time messaging between the first and second entities;
transmit pre-configured non-disclosure agreements upon initiating sensitive discussions to ensure privacy; and
log communication events, timestamps, and non-disclosure agreement metadata;
a data management module configured to:
store and organize first and second entities' profiles, message logs, and interaction histories; and
maintain audit trails for regulatory compliance;
a content update provider enabling the second entity to deliver real-time updates on therapeutic products, first entity clinical trials, and collaboration opportunities; and
a privacy and security module configured to:
encrypt data during transmission and storage;
provide entity-controlled permissions for content access; and
automate log deletion for non-disclosure agreement-protected discussions after a predefined period.

2. The system of claim 1, wherein the communication subsystem categorizes messages by therapeutic area, trial phase, or sender department.

3. The system of claim 1, further comprising:
a virtual platform hosted on:
a support server and a support cloud server for managing data storage, communication processing, and entities interaction logs; and
a network server configured for secure, real-time data exchange between the first entity portal and the second entity portal.

4. The system of claim 3, wherein the network server employs distributed ledger technology for data integrity and traceability.

5. The system of claim 1, further comprising:
a second data management module employing machine learning to:
analyze interactions of the first and second entities to generate personalized recommendations for first entity clinical trials, collaborations, and connections;
identify potential synergies using external datasets; and
predict emerging trends in the first entity and the second entity collaborations.

6. The system of claim 4, wherein the second data management module utilizes natural language processing to analyze message content and refine collaboration suggestions.

7. The system of claim 1, further comprising:
an artificial intelligence controller configured to:
integrate external data sources, including at least one of first entity surveys, content management system data, National Comprehensive Cancer Network guidelines, and medical journal publications; and
dynamically update communication workflows and recommendations.

8. The system of claim 6, wherein the artificial intelligence controller predicts emerging research trends and suggests partnerships accordingly.

9. The system of claim 6, wherein the artificial intelligence controller dynamically adjusts recommendations based on real-time interactions of the first entity and the second entity.

10. The system of claim 1, wherein the content update provider includes tools for automating the delivery of real-time updates on first entity clinical trials to matched clinicians.

11. The system of claim 1, wherein the privacy and security module incorporates multi-factor authentication for verification of at least one of the first entity and the second entity.

12. The system of claim 1, wherein the first entity portal provides a dashboard displaying trial recommendations, recent communications, and upcoming collaboration opportunities.

13. The system of claim 1, further comprising:
a first entity survey module integrated into the platform to gather and analyze clinician feedback on clinical trials and collaborations.

14. The system of claim 13, wherein the first entity survey module anonymizes feedback data for the second entity analysis while preserving clinician confidentiality.

15. A method for enabling collaboration between a first entity and a second entity using a virtual platform, comprising:
providing a first entity portal for the first entity to access via at least one of a smartphone application and a web login, wherein the first entity creates a profile specifying research interests, therapeutic expertise, and collaboration goals, and wherein the first entity filters clinical trials of the first entity and the second entity by criteria including therapeutic area or trial phase;
providing a second entity portal for the second entity to access via at least one of a smartphone application and a web login, wherein the second entity uploads and classifies content, including therapeutic pipelines and first entity trial updates, and wherein the second entity portal targets the first entity based on research alignment;
facilitating communication through a communication subsystem, by enabling real-time messaging between the first entity and the second entity, transmitting pre-configured non-disclosure agreements upon initiating sensitive discussions, and recording interaction logs and associated metadata for traceability;
analyzing interactions of the first and second entities using a second data management module employing machine learning to generate personalized recommendations for first entity clinical trials, collaborations, and partnerships; predict potential synergies between first and second entities; and identify trends in the engagement of the first and second entities;
utilizing an artificial intelligence controller to integrate external data from first entity surveys, content management system datasets, National Comprehensive Cancer Network guidelines, and medical journals; and generate recommendations and workflows based on evolving first and second entities behavior;
enabling the second entity to deliver trial updates and therapeutic content through a content update provider;
gathering feedback via a first entity survey module for analysis and reporting; and
securing interactions with a privacy and security module configured to encrypt data, manage permissions, and automate log deletion for non-disclosure agreement-protected discussions.

16. The method of claim 15, further comprising enabling clinicians to sort potential collaborations by geographic location of the trial sites or sponsors.

17. The method of claim 15, further comprising integrating external electronic health records into the virtual platform for data sharing.

18. The method of claim 15, further comprising enabling clinicians to receive real-time alerts for updates matching their first entity interests.

19. The method of claim 15, further comprising enabling the second entity to access engagement metrics, including response rates and message open rates, for optimizing communication strategies.

20. A system for facilitating collaboration between a first entity and a second entity, comprising:
a first entity portal accessible via at least one of a smartphone application or web login, the first entity portal configured to allow the first entity to:
create and manage profiles specifying at least one of first entity specialties, research interests, and collaboration goals;
filter and select clinical trials of the first entity and the second entity based on therapeutic area and clinical trial phase; and
initiate secure communications with the second entity;
a second entity portal accessible via at least one of a smartphone application or web login, the second entity portal configured to allow the second entity to:
upload and manage therapeutic pipelines, first entity trial updates, and research opportunities;
classify content by clinical trial phase, therapeutic area, and geographic region; and
interact with the first entity based on shared research goals;
a virtual platform hosted on:
a support server and a support cloud server for managing data storage, communication processing, and entities interaction logs; and
a network server configured for secure, real-time data exchange between the first entity portal and the second entity portal;
a communication subsystem configured to:
facilitate real-time messaging between the first and second entities;
transmit pre-configured non-disclosure agreements upon initiating sensitive discussions to ensure privacy; and
log communication events, timestamps, and non-disclosure agreement metadata;
a first data management module configured to:
store and organize first and second entities' profiles, message logs, and interaction histories; and
maintain audit trails for regulatory compliance;
a second data management module employing machine learning to:
analyze interactions of the first and second entities to generate personalized recommendations for first entity clinical trials, collaborations, and connections;
identify potential synergies using external datasets; and
predict emerging trends in the first entity and the second entity collaborations;
an artificial intelligence controller configured to:
integrate external data sources, including first entity surveys, content management system data, National Comprehensive Cancer Network guidelines, and medical journal publications; and
dynamically update communication workflows and recommendations;
a content update provider enabling the second entity to deliver real-time updates on therapeutic products, first entity clinical trials, and collaboration opportunities;
a first entity survey module integrated into the platform to gather and analyze clinician feedback on clinical trials and collaborations; and
a privacy and security module configured to:
encrypt data during transmission and storage;
provide entity-controlled permissions for content access; and
automate log deletion for non-disclosure agreement-protected discussions after a predefined period.
